(19) United States
(12) Patent Application Publication
(10) Pub. No.: US 2007/0170116 A1
(43) Pub. Date: Jul. 26, 2007

(54) Refuse processing method

(76) Inventor: Eric Martin, Velizy (FR)

Correspondence Address: JACOBSON HOLMAN PLLC, 400 SEVENTH STREET N.W., SUITE 600, WASHINGTON, DC, 20004, US

(21) Appl. No.: 11/587,164

(22) PCT Filed: Mar. 9, 2005
(86) PCT No.: PCT/FR05/00561

§ 371 Date: Oct. 20, 2006

(30) Foreign Application Priority Data
Apr. 23, 2004 (FR) 0404336

(51) Int. Cl. C02F 1/48

(52) U.S. Cl. 210/695; 210/749; 241/20; 210/205; 210/259; 210/806; 210/202; 209/12.1; 209/214; 209/155

(57) ABSTRACT

This method of processing refuse including organic and non-organic materials is noteworthy in that it comprises the steps of: A) admixing quicklime and a highly slaked substance with said refuse, B) allowing the reaction between said organic materials to proceed to produce a product that includes a calcium organic complex and said non-organic materials, and C) separating said non-organic materials from said calcium organic complex.

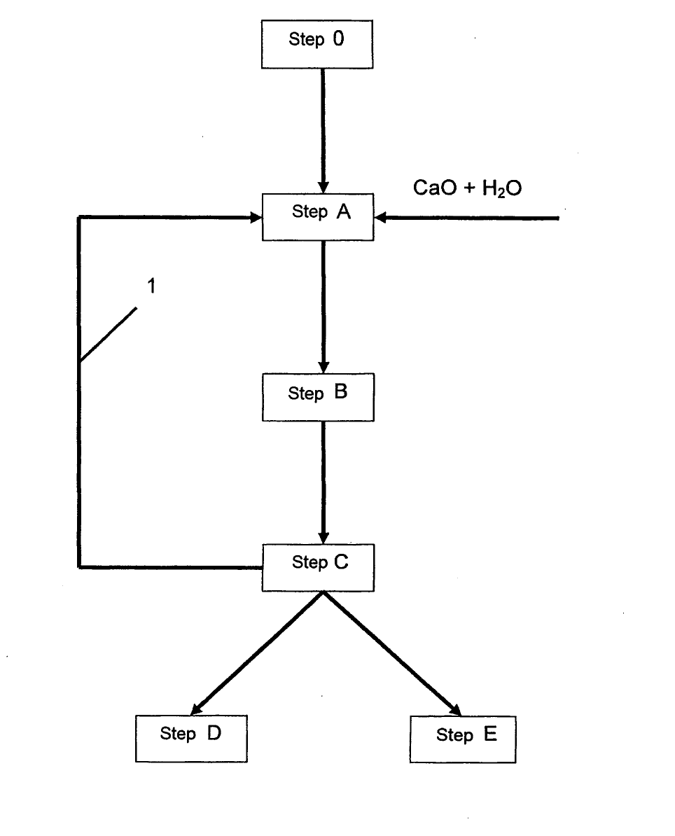

The present invention relates to a refuse processing method.

There is known from the document WO 01/85646 a refuse processing method of the type in which the refuse is admixed with quicklime and a strongly slaked substance such as purification station sludge and/or grease, the chemical reaction is allowed to take place in this mixture for a certain time, and the deslaked product resulting from this reaction is then ground.

In the above prior art process, there is provision for extracting from the refuse, prior to the admixture of the refuse with the quicklime and the strongly slaked substances, non-organic materials that could not be extracted therefrom subsequently by aeraulic means (cyclones, etc.). These non-organic materials extracted beforehand include ferrous and non-ferrous metals, glass, etc.

This extraction beforehand, effected by standard sorting means, is nevertheless often difficult.

It has become clear in fact that the non-organic materials from such refuse tend to bond to the organic materials, thereby making it difficult to separate these two categories of materials.

One object of the present invention is to eliminate this problem.

This object of the invention is achieved with a method of processing refuse including organic and non-organic materials, noteworthy in that it comprises the steps of:

A) admixing quicklime and a highly slaked substance with said refuse,

B) allowing said organic materials to react to give a product that includes a calcium organic complex and said non-organic materials, and

C) separating said non-organic materials from said calcium organic complex.

The reaction that occurs between the organic materials from the refuse, the quicklime and the strongly slaked substance dehydrates the organic material and thereby produces a product in which the non-organic materials (which have not reacted) are easily separated from the remainder of the product, i.e. from the calcium organic complex.

Thus it is a very simple matter to separate these non-organic materials from the calcium organic complex by conventional means.

According to further, optional features of the method of the invention:
the method includes the step D) of sorting the non-organic materials obtained at the end of the step C),
the method comprises the step 0) of dividing said refuse in accordance with a predetermined particle size range prior to the step A),
at least a portion of said calcium organic complex obtained at the end of the step C) is re-injected into the mixture of the step A),
the method comprises the step E) of screening said calcium organic complex according to a predetermined particle size range,
the strongly slaked substance is a substance selected from the group comprising purification station sludges and greases,
at least one compound selected from the group comprising green refuse, cellulose-based materials, slurry, droppings, peat is added to the mixture of the step A),
a confinement area having a moving bottom is used to implement the step B),
a static confinement area is used to implement the step B),
separation and sorting means for implementing the steps C) and/or D) and/or E) are selected from the group comprising screening means, magnetic means, Eddy current means and gravity means.

The present invention also relates to an installation for implementing a method according to any one of the preceding claims, noteworthy in that it comprises, in this order from the entry point of the refuse to be processed:
means for mixing said refuse with said quicklime and said strongly slaked substance,
means for allowing said reaction to take place, and
means for separating said non-organic materials from said calcium organic complex.

According to further, optional features of the installation:
the installation further comprises means for sorting the non-organic materials obtained at the end of the step C),
the installation comprises, upstream of said mixing means, means for dividing said refuse according to a predetermined particle size range,
the installation comprises, downstream of said extraction means, means for screening said fraction in accordance with a predetermined particle size range,
said means for allowing said reaction to take place comprise a moving bottom confinement area,
said means for allowing said reaction to take place comprise a static confinement area.

Other features and advantages of the present invention will become apparent on reading the following description and examining the appended single FIGURE, which is a diagram representing the main steps of the method of the invention.

According to the preamble of the present description, in everything hereinafter (description and claims), the expression “non-organic materials”refers specifically to non-organic materials that cannot be extracted from the refuse by aeraulic means (cycloning, etc.) following the chemical reaction with the lime.

Those non-organic materials comprise in particular ferrous and non-ferrous metals, glass, etc.

The refuse to be processed is preferably domestic refuse, which generally arrives at the processing site in plastic sacks tipped into a receiving area.

This kind of receiving area may typically comprise a plurality of metal casings with moving bottoms operating in accordance with the FIFO (first in, first out) principle.

This refuse typically comprises organic materials and non-organic materials.

A start is preferably made, in the step 0, by shearing and/or grinding and/or lacerating the sacks of refuse to obtain fragments having a predetermined particle size range (typically of the order of 80 to 100 mm).

In the step A, the quicklime (CaO) and a strongly slaked substance is mixed with the refuse.

For example, the strongly slaked substance may consist of purification station sludge and/or grease.

The mixing operation may be effected by any appropriate device known to the person skilled in the art, for example of the type comprising a lead screw turning inside a mixing tank.

In the step B, the chemical reaction between the refuse, the quicklime and the strongly slaked product is allowed to occur.

As is known in the art, this chemical reaction may be written as follows:
Organic materials+CaO+H₂O→calcium organic complex+CO₂+H₂O (steam)+other gases (NH₃, NH₄, etc.).

This strongly exothermic reaction may take place within a static confinement area, such as a ditch or a closed casing.

However, apparatus with a moving bottom of the type described in the application PCT/FR00/01250, published 15 Nov. 2001 under the number WO 01/85645, is preferably used.

The time necessary for the chemical reaction mentioned above to take place exceeds 30 minutes and is generally from two to four hours.

After the step B, a product is obtained whose moisture content has been greatly reduced, i.e. a product having a dry appearance.

This product comprises on the one hand a calcium organic complex resulting from said chemical reaction and on the other hand said non-organic materials which have remained inert in relation to this chemical reaction.

Because of the low moisture content of the product obtained after the step B, it is a very simple matter to separate the non-organic materials (ferrous metals and non-ferrous metals, glass, etc.) from the calcium organic complex during the step C and to sort these non-organic materials during the step D.

The means used to separate the non-organic materials from the calcium organic complex and for sorting the non-organic materials are conventional and may typically comprise:
screening means,
magnetic means (of the overband type) for extracting ferrous metals,
Eddy current means for extracting non-ferrous metals,
gravity means (of the vibrating table type) for separating the heaviest elements from the lightest elements, etc.

In the step E, the calcium organic complex is screened to obtain a powder product typically having a particle size range from 0 to 20 mm or more if necessary.

There is obtained in this way a product that may be suitable in particular for organic calcium-rich soil improvers for use in agriculture.

It will be noted that provision may be made for adding to the mixture of the step A other carbon-containing compounds, such as green refuse (for example grass clippings), cellulose-based materials (paper, cardboard), slurry, droppings, peat, etc.

It will also be noted that at least a portion of the calcium organic complex may be re-injected into the mixture of the step A (see reference 1 in the appended figure).

This operation adapts the relative proportions of organic materials and quicklime in the mixture of the step A and thus produces in the end a product that always has substantially the same composition.

In this way it is possible to comply with invariance constraints imposed by applicable regulations.

By way of illustrative and nonlimiting example, the proportions by weight of the various constituents of the chemical reaction mentioned above are as follows:
materials constituting the refuse: from 20 to 70%,
quicklime from 10 to 30%,
strongly slaked substance (water where applicable charged with organic materials) from 10 to 60%.

As is clear in the light of the foregoing description, by dehydrating all the refuse, the invention makes it very easy to separate non-organic materials from organic materials.

The invention also facilitates sorting these non-organic materials from each other, given that after the step B the non-organic materials have been rendered hygienic, i.e. they no longer contain any pathogens and/or putrid substances.

Because these non-organic materials no longer represent a hazard to humans at the end of step B, manual sorting may even be envisaged.

Of course, the present invention is not limited to the embodiment described, which is provided by way of purely illustrative example.

1-16. (canceled)

17. Method of processing refuse including organic and non-organic materials, comprising the steps of:
A) admixing quicklime and a highly slaked substance with said refuse,
B) allowing said organic materials to react to give a product that includes a calcium organic complex and said non-organic materials, and
C) separating said non-organic materials from said calcium organic complex.

18. Method according to claim 17, further including the step D) of sorting the non-organic materials obtained at the end of the step C).

19. Method according to claim 17, further comprising the step 0) of dividing said refuse in accordance with a predetermined particle size range prior to the step A).

20. Method according to claim 17, wherein at least a portion of said calcium organic complex is re-injected into the mixture of the step A).

21. Method according to claim 17 comprising the step E) of screening said calcium organic complex according to a predetermined particle size range.

22. Method according to claim 17, wherein the strongly slaked substance is a substance selected from the group comprising purification station sludges and greases.

23. Method according to claim 17, wherein at least one compound selected from the group comprising green refuse, cellulose-based materials, slurry, droppings, peat is added to the mixture of the step A).

24. Method according to claim 17, wherein a confinement area having a moving bottom is used to implement the step B).

25. Method according to claim 17, wherein a static confinement area is used to implement the step B).

26. Method according to claim 17, wherein separation and sorting means for implementing the steps C) and/or D) and/or E) are selected from the group comprising screening means, magnetic means, Eddy current means and gravity means.

27. Installation for implementing the method according to claim 17 comprising in this order from the entry point of the refuse to be processed:
means for mixing said refuse with said quicklime and said strongly slaked substance,
means for allowing said reaction to take place, and
means for separating said non-organic materials from said calcium organic complex.

28. Installation for implementing the method according to claim 18 comprising in this order from the entry point of the refuse to be processed:
means for mixing said refuse with said quicklime and said strongly slaked substance,
means for allowing said reaction to take place,
means for separating said non-organic materials from said calcium organic complex, and
means for sorting the non-organic materials.

29. Installation for implementing the method according to claim 19 comprising in this order from the entry point of the refuse to be processed:
means for mixing said refuse with said quicklime and said strongly slaked substance,
means for allowing said reaction to take place,
means for separating said non-organic materials from said calcium organic complex, and
means, upstream of said mixing means, for dividing said refuse according to a predetermined particle size range.

30. Installation for implementing the method according to claim 21 comprising in this order from the entry point of the refuse to be processed:
means for mixing said refuse with said quicklime and said strongly slaked substance,
means for allowing said reaction to take place,
means for separating said non-organic materials from said calcium organic complex, and
means, downstream of said extraction means, for screening said fraction in accordance with a predetermined particle size range.

31. Installation for implementing the method according to claim 24 comprising in this order from the entry point of the refuse to be processed:
means for mixing said refuse with said quicklime and said strongly slaked substance,
means for allowing said reaction to take place, and
means for separating said non-organic materials from said calcium organic complex,
wherein said means for allowing said reaction to take place comprises a moving bottom confinement area.

32. Installation for implementing the method according to claim 25 comprising in this order from the entry point of the refuse to be processed:
means for mixing said refuse with said quicklime and said strongly slaked substance,
means for allowing said reaction to take place, and
means for separating said non-organic materials from said calcium organic complex,
wherein said means for allowing said reaction to take place comprises a static confinement area.
